(19) United States
(12) Patent Application Publication
(10) Pub. No.: US 2009/0325657 A1
(43) Pub. Date: Dec. 31, 2009

(54) CUSTOMIZABLE UNIVERSAL PROTECTIVE CASE FOR A PORTABLE ELECTRONIC DEVICE

(75) Inventors: Richard A. Ramsdell, Irvine, KY (US); Scott A. Eppert, West Chester, OH (US); Liu Hans, Rosemead, CA (US); Harry Mkhitarian, Pasadena, CA (US)

Correspondence Address: KING & SCHICKLI, PLLC, 247 NORTH BROADWAY, LEXINGTON, KY, 40507, US

(73) Assignee: PRIME FINISH, LLC, Paris, KY (US)

(21) Appl. No.: 10/585,395

(22) PCT Filed: Jan. 6, 2005
(86) PCT No.: PCT/US2005/000270

§ 371 Date: Sep. 10, 2009

Related U.S. Application Data
(60) Provisional application No. 60/534,475, filed on Jan. 6, 2004.
(60) Provisional application No. 60/607,012, filed on Sep. 3, 2004.
(60) Provisional application No. 60/614,762, filed on Sep. 29, 2004.

(51) Int. Cl. H04M 1/00; B65D 69/00

(52) U.S. Cl. 455/575.8; 206/459.5

(57) ABSTRACT

A user-customizable case is provided for at least partially covering a portable electronic device. The case may include first and second panels and a retainer for holding an insert bearing an indicia. The panels may be elastically connected to facilitate receiving many different sizes and shapes of portable electronic devices. The retainer may removably attach to the case to facilitate exchanging the inserts for customizing the device, insignia, or the like. The case may be included in a kit, along with at least one insert and a retainer. Related methods are also disclosed.

### TECHNICAL FIELD

The present invention relates generally to protective cases and, more specifically, to a customizable universal protective case for a portable electronic device.

### BACKGROUND OF THE INVENTION

Portable electronic devices, such as mobile phones and personal digital assistants (PDA), are ubiquitous. Most users carry these devices in protective cases, and often wish to customize the same. For instance, users often wish to individualize their case to distinguish it from the case of another. Others view the cases as fashion accessories and wish to keep up with the latest style(s). Still others desire cases that convey a message or show allegiance to a particular university, club, association, or organization, such as a professional sports team.

To meet these demands, manufacturers have in the past offered cases with various color schemes, designs, insignias, and the like. Unfortunately, such cases are specifically designed for use with only a single type of electronic device, such as a particular model of mobile phone. Thus, when a user purchases a new or different model of a portable electronic device, a corresponding case bearing the desired design or insignia must also be purchased to go along with it. Moreover, if an individual wishes to display different designs or insignias, multiple cases must be purchased for the same device, thus resulting in additional expense. The requirement that the manufacturer and retailer maintain a large stock of the different types of cases, including with different designs and logos, is also burdensome since it greatly increases overhead expenses.

Additionally, with the rapid evolution of technology in the area, manufacturers continuously upgrade and modify the designs of electronic devices. As a result, the devices continually change shape and size. This, of course, requires case manufacturers to retool their assembly lines with regular frequency in an effort to accommodate the different devices, thus creating obvious inefficiencies of scale.

Accordingly, a need is identified for an easily customizable, universal protective case for a portable electronic device. The case would be adapted for use with electronic devices of various sizes and shapes, which eliminates the requirement for purchasing a separate or different case for each portable electronic device, even when a new or different model is obtained. The ability of the user to customize the case would also allow for personalization, such as to display a current style or affiliation, without the need for wholesale replacement. These features when combined would not only greatly extend the service life of the case beyond the whims of the user or the current trends, but also would eliminate the present requirement for maintaining a stock of different types of cases with differing stylizations. Overall, the result would be a significant savings in terms of time and money, both for the case manufacturer and the end user.

### SUMMARY OF THE INVENTION

In accordance with one aspect of the invention, a kit for protecting and customizing a portable electronic device is provided. The kit comprises a plurality of inserts, each for receiving an indicia. A case forming part of the kit includes an open end for receiving the device and a retainer for removably holding at least one of the inserts for viewing. As a result, the indicia on a particular insert may be visualized, and then the insert removed and replaced as desired to customize the device.

In one embodiment, the retainer is hingedly attached to the case to facilitate insertion and removal of the inserts during customization. The kit may further include the portable electronic device, such as a mobile phone, as well as instructions for removing and replacing the inserts. Preferably, the inserts and case are displayed in a common package. The kit may further include decals for the inserts.

In accordance with another aspect of the invention, a user-customizable case for at least partially covering a portable electronic device is disclosed. The case comprises a body including a first panel and a second panel, as well as a retainer for holding an insert for receiving an indicia. The panels are elastically connected and the retainer is removably attached to the first panel (such as by way of a hinge and snap-fit engagement) to allow for removal and replacement of the insert (which may bear a pre-printed logo or the like).

In accordance with yet another aspect of the invention, a user-customizable case for a portable electronic device is disclosed. The case comprises a body including an elongated front panel, a corresponding back panel, and an elastic member for securely connecting the front panel with the back panel to create a compartment. A retainer is also provided for holding an insert. The retainer may be removably attached to the body, such as by a snap-fit engagement.

In accordance with still another aspect of the invention, a user-customizable case for a portable electronic device comprises a body including an open end for receiving the portable electronic device, at least one insert bearing an indicia, and a retainer for holding the insert. The retainer is hingedly attached to the body. This facilitates inserting, removing, or replacing the insert to effect customization of the case.

In accordance with a further aspect of the invention, a method of associating an insert with a user-customizable case adapted for at least partially covering a portable electronic device is disclosed. The method comprises moving a retainer associated with the case from a retracted position close to the case to an extended position away from the case; positioning the insert between the retainer and the case; and returning the retainer to the retracted position to associate the insert with the case. The method may further include the step of placing a logo on the insert, such that the logo is visible when positioned between the retainer and the case. The retainer may also include a locking projection for engaging a frame associated with the case, in which case the step of moving the retainer is preceded by releasing the locking projection. The step of releasing the locking projection preferably comprises backbending a panel of the case that carries the frame.

In accordance with still a further aspect of the invention, a method of facilitating customization of a portable electronic device is disclosed. The method comprises providing a case including an open end for receiving the portable electronic device. The case includes a removable retainer for receiving at least one insert having an indicia, and the method further comprises providing a plurality of different inserts for the retainer. The inserts may be exchanged for each other in the retainer to customize the case.

The method may further include placing at least one insert in the retainer for display purposes and placing at least one insert adjacent the case. Alternatively, the inserts may be enclosed in a common package, including for display. Decals for the inserts may also be provided.

### BRIEF DESCRIPTION OF THE DRAWINGS

FIG. 1 is an exploded view of one possible embodiment of the case;

FIG. 2 is a front view of the case of FIG. 1;

FIG. 2a is a sectional view taken along the line A-A of the case of FIG. 2;

FIG. 3 is a front view of a retainer used in the case of FIG. 1;

FIG. 3a is a side view of the retainer of FIG. 3;

FIG. 3b shows the lip or edge of the holder adapted to engage a portion of the cover;

FIG. 4 is a sectional view along the line A-A of the case of FIG. 2;

FIG. 4a shows the retainer in a mounted position;

FIG. 5 is a perspective view of the assembled case of FIG. 1; and

FIGS. 6-9 illustrate another possible embodiment of the case.

### DETAILED DESCRIPTION OF THE INVENTION

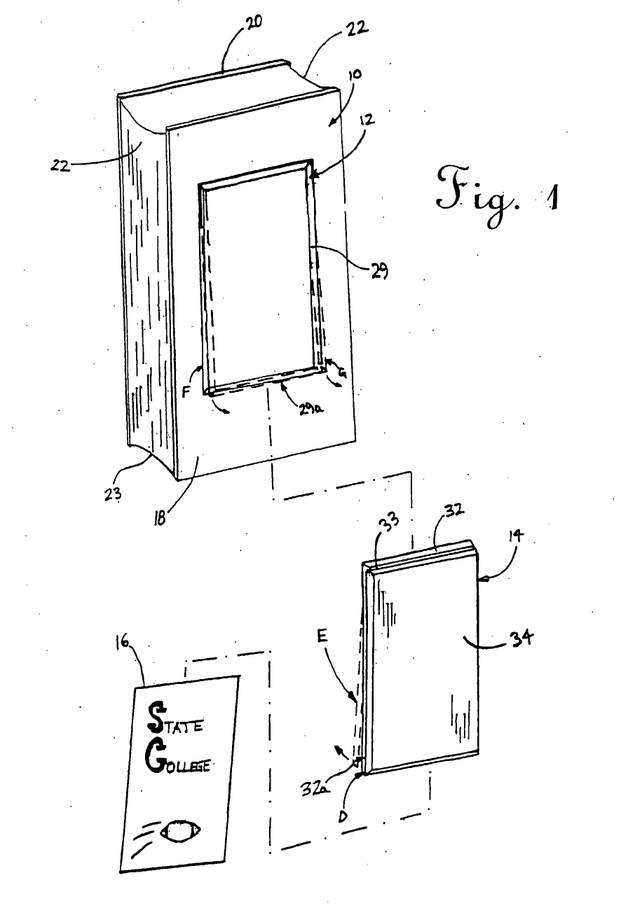

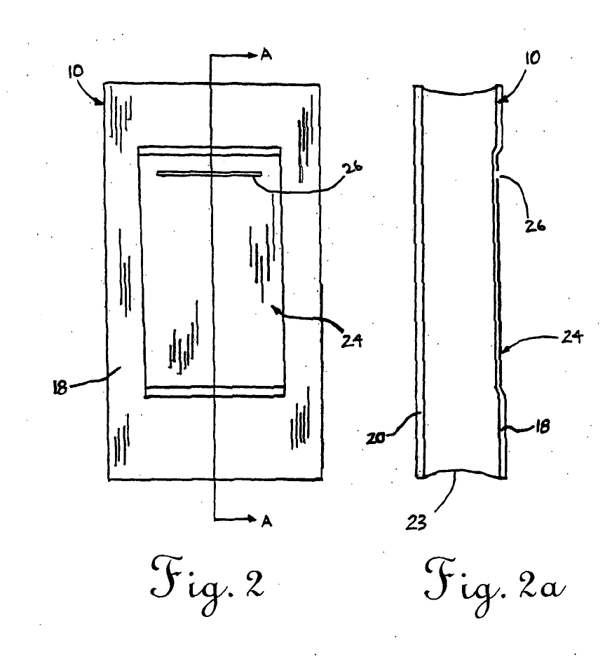

Reference is now made to FIG. 1 illustrating one embodiment of the protective case 10 forming one aspect of the present invention. As noted above, one of the features of the case 10 is its ability to not only accommodate myriad portable electronic devices or the like, but also to be easily customized to suit the likes of a particular user. In one embodiment, customization is accomplished by associating an insert 16 bearing or capable of bearing an image (design, logo, or other indicia) with a holder 14, which attaches or secures to the case 10 by a removable retainer 12.

In the illustrated embodiment, the case 10 is generally elongated and of the type having an open end for receiving the portable electronic device (see FIG. 5, which shows a similarly elongated “candy bar” type of mobile phone 36 as the device for purposes of illustration only). Thus, it includes an elongated front panel 18, a corresponding back panel 20, at least two opposed, elongated side panels 22, and a bottom panel 23, which together define a compartment. The front and back panels 18, 20 are preferably rigid or substantially rigid, which helps to protect the device when positioned in the case 10. The side and bottom panels 22, 23 may be rigid as well, but preferably are made of an elastic member attached to the front and back panels 18, 20 (such as by sewing, welding, etc.). This elasticity advantageously allows various sizes of devices to be accommodated (e.g., PDAs, folding cell phones, “candy bar” cell phones, cameras, pagers, etc.), and may also assist in securing the device within the case 10 by applying a frictional force.

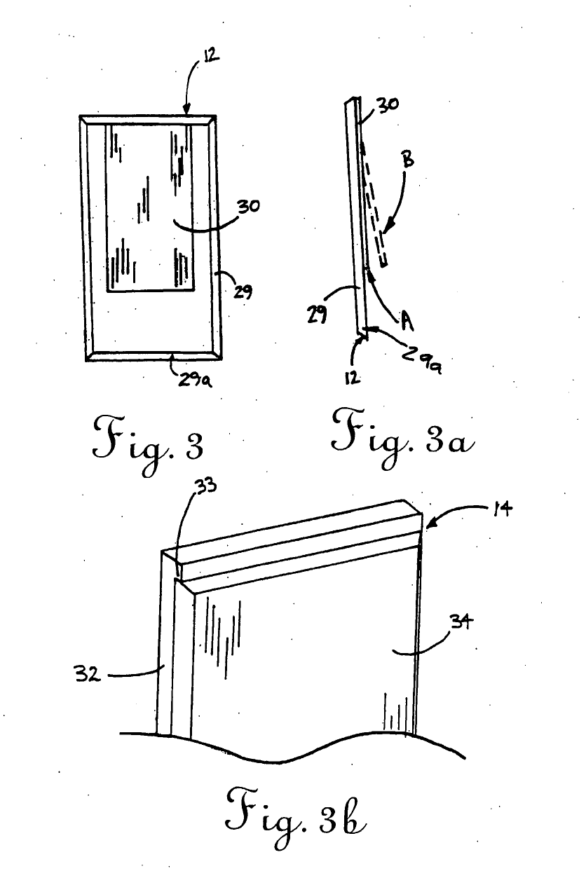

As shown in FIG. 2, the front panel 18 of the case 10 preferably includes a recess or indentation 24, as well as an opening 26 adapted for receiving the retainer 12. The indentation 24 may be formed by pressing the desired shape into the outer surface of the front panel 18 using a die or the like such that it is permanently formed. The opening 26 is preferably an elongated slit oriented generally parallel to a top or bottom edge of the case 10.

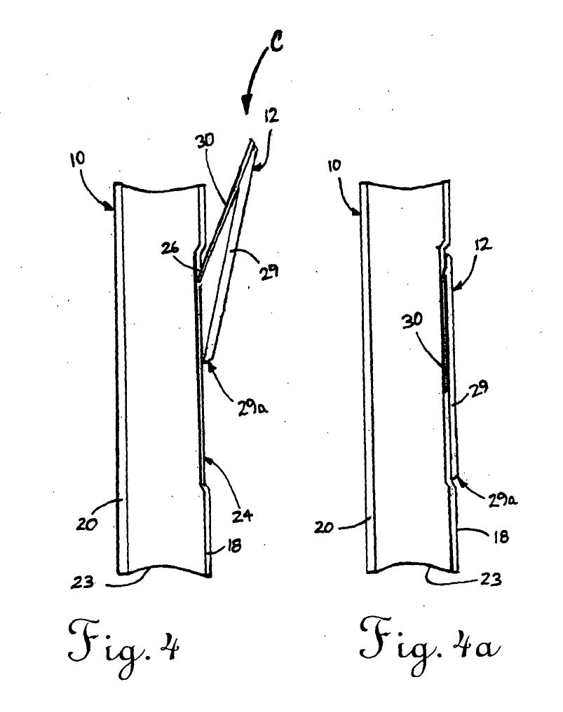

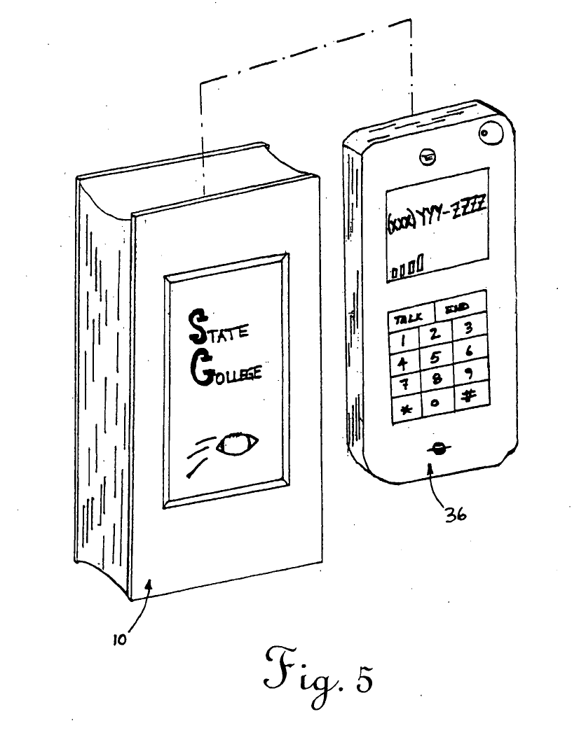

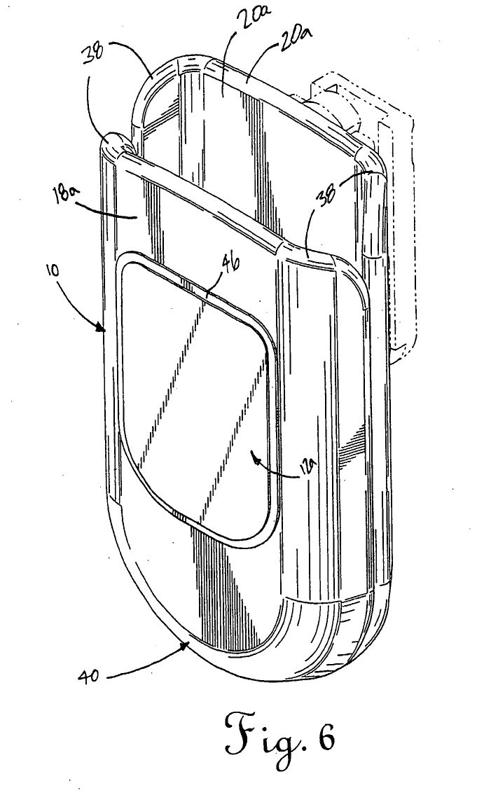

With reference now to FIGS. 1 and 3, the retainer 12 in the illustrated embodiment includes a support and a fastener. The support, such as a frame 29, defines a generally rectangular perimeter around a center opening in which the fastener, such as a clip 30, is positioned. Preferably, only one end of the clip 30 is attached or secured to the support, thus establishing a cantilevered-type mounting. The clip 30 may be formed as one piece with the support, such as via injection molding. Alternatively, the clip 30 may be a separate piece attached to the frame 29, such as by welding. As best seen in FIG. 3a, the clip 30 naturally resides at a home position A, which may be in a plane parallel to the frame 29. However, when attached at only one end, as is done in the embodiment shown, it may be manually flexed and temporarily repositioned in a second position B.

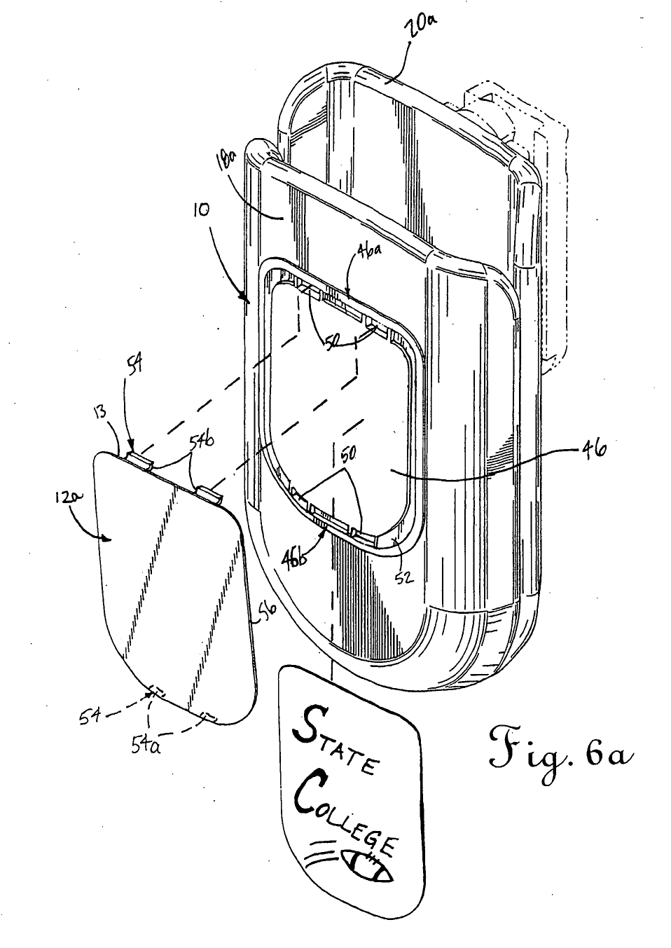

Turning now to FIGS. 4 and 4a, it can be seen that the retainer 12 attaches to the case 10 via insertion of the clip 30 into the opening 26, usually when fully in the second position B. The retainer 12 is then moved in the direction of action arrow C to position the clip 30 within the opening 26, thus completing the attachment sequence in its simplest form. As should be appreciated by a skilled artisan, the longitudinal dimension of the clip 30 is preferably such that it remains securely retained in the opening 26 (which may or may not be associated with a pocket).

Once inserted, the frame 29 of the retainer 12 is received by or seated in the indentation 24 or recess. Once in this fully inserted position, the propensity of the clip 30 to assume the home position A due to the cantilevered mounting and the corresponding biasing force created ensures that the retainer 12 remains secured to the case 10 (similar to the manner in which a paper clip remains secured to a piece of paper). The indentation 24 provided in the case 10 also ensures that the support, or frame 29, lies in substantially the same plane as the front panel 18 (see FIG. 4a). Indeed, as illustrated, the periphery of the frame 29 may be chamfered, beveled, contoured or otherwise shaped to engage any slope created in the four “sidewalls” defining the indentation 24.

Turning now to FIGS. 1 and 3b, the image holder 14 is now described in detail. In the illustrated embodiment, the holder 14 comprises an image retainer in the form of a flap 32, as well as an associated cover 34. In one embodiment, the flap 32 includes a first portion 32a and an opposed lip or edge 33. The lip 33 is adapted to engage a portion of the cover 34 (such as the upper edge when oriented as shown in FIG. 1). The flap 32 is attached to the cover 34, such as by way of a thermal process (e.g., ultrasonic or laser welding when suitable plastic materials are used), an adhesive, or similar attachment means, such that a living hinge is established. Although not a requirement, the attachment is preferably made such that a small gap or space is created between the corresponding inner surfaces of the flap 32 and cover 34.

As a result of this arrangement, the lower portion 32a of the flap 32 may be moved from a first or home position D adjacent to the cover 34 toward a temporary second position E farther away from the cover. When not in the home position and preferably in the second position, the insert 16 may be placed between the flap 32 and the cover 34. The cover 34 is preferably formed of a transparent or translucent material. It thus forms a window or lens for visualization of the insert 16.

The insert 16 may comprise any substrate formed of any solid material carrying a design, insignia, image, or other indicia. Examples include a sticker or decal applied to a substrate, printing on a substrate, or any other suitable arrangement. Preferably, the insert 16 is formed from a relatively thin piece of material so as to fit within the space or gap between the flap 32 and cover 34 (or if no such space or gap is provided, to allow the flap 32 to return to substantially the home position). However, providing a thicker insert 16 is possible, as is providing a corresponding recess (not shown) in the flap 32 or cover 34 for receiving it (but this, of course, increases the complexity).

More specifically describing the manner of associating the insert 16 with the holder 14 shown in FIG. 1, the user may grasp the lower portion 32a of the flap 32 and move it toward the temporary, second or extended position E. The desired insert 16 is then associated with the holder 14, such as by placing it between the flap 32 and the cover 34, with the image side facing the inside surface of the latter. Next, the user returns the lower portion 32a of the flap 32 to its home or retracted position D. The propensity of the flap 32 to remain at the home position D as a result of the manner in which it is mounted (i.e., the living hinge) provides the holding force to secure the insert 16 in the holder 14. To associate or match the holder 14 with the case 10, the user grasps the lower portion 29a of the frame 29 of the retainer 12 and moves it toward a temporary second position G. Once in the temporary second position, the holder 14 is positioned between the frame 29 of the retainer 12 and the case 10, and the retainer 12 returned to the seated position F. This extraordinarily simple procedure completes the steps for placing an insert 16 into the case 10.

As should be appreciated, replacing the insert 16 on the case 10 is accomplished by merely lifting the portion 29a of the frame 29. The holder 14 is then simply manually grasped and removed. The portion 32a of the flap 32 may then be lifted to allow for removal of the existing insert 16 and a new one inserted. Under normal circumstances, the entire replacement sequence takes a matter of seconds, thus allowing the user to easily customize the case with minimum effort.

FIG. 5 illustrates the case 10 including the retainer 12 securing the holder 14 for retaining an insert 16. A representative electronic device, such as a cell phone 36, is also depicted, ready for insertion into the case 10 (usually from the end opposite the antenna (not shown)). As described below, one or more of these items (including a plurality of inserts) may be enclosed in a common package and sold together as a kit, or may be sold as individual units for later assembly.

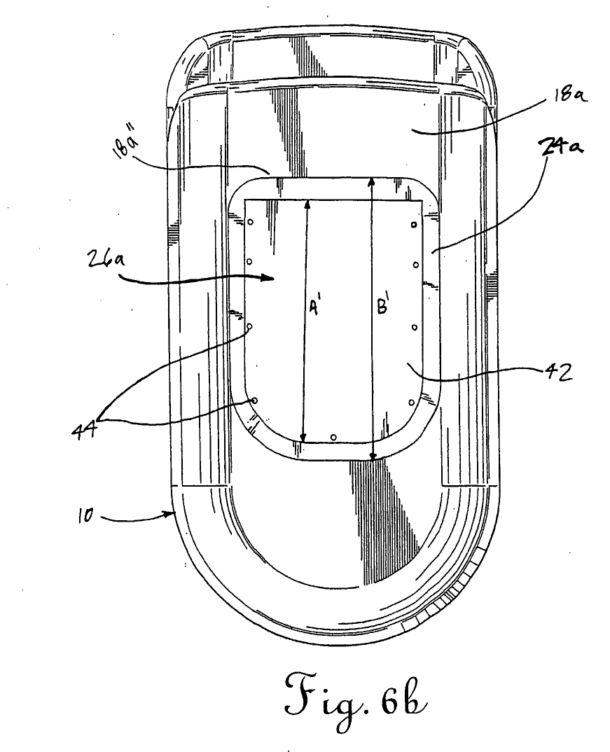

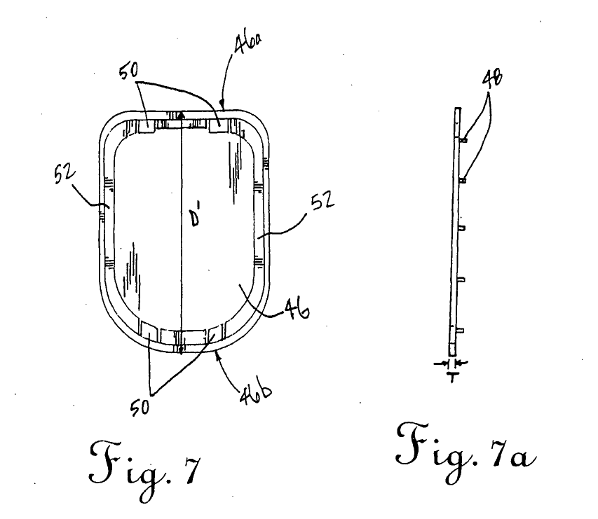

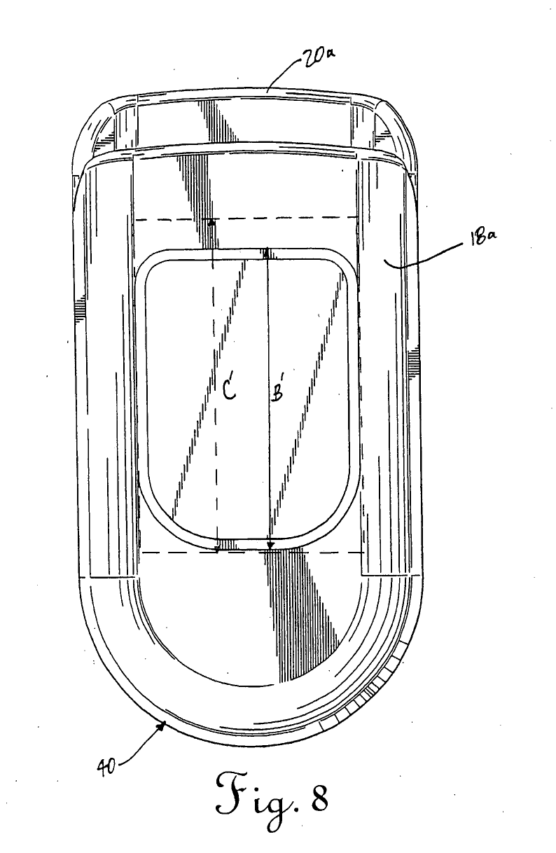

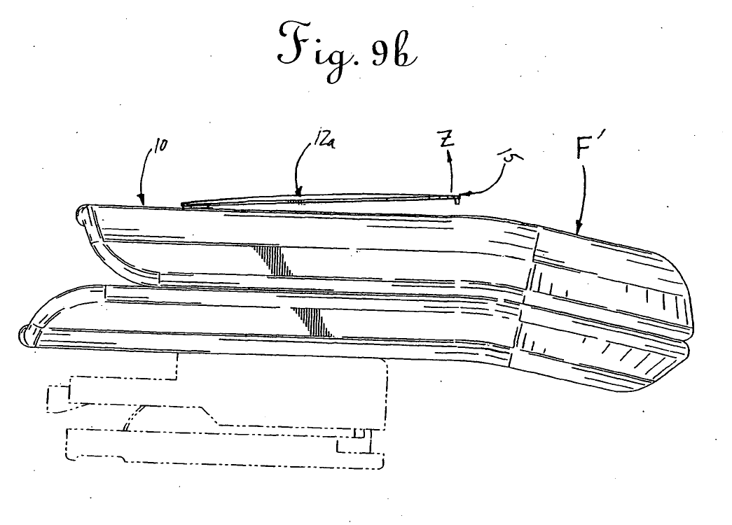

In another embodiment shown in FIGS. 6-9, the case 10 comprises “clamshell”-like design with an elongated front panel 18a having curved edges 38, an arcuate region 40, and a substantially corresponding back panel 20a. As best seen in FIG. 9, the back panel 20a may optionally extend a distance D1 beyond the perimeter of the front panel 18a. This configuration of panels 18a, 20a facilitates user access to the contents of the case 10 and also provides it with a unique aesthetic appearance. The curved edges 38 and arcuate region 40 enable the case to accommodate many of today's compact portable electrical devices, including foldable, or “flip,” mobile phones, media players, cameras, etc.

Similar to the previously discussed embodiments, the case 10 may also include at least two opposed side panels 22a and a bottom panel 23a, as perhaps best shown in FIG. 9a. The front and back panels 18a, 20a are preferably substantially rigid, which helps to protect the device when positioned in the case. However, the front and back panels 18a, 20a may have some flexibility to facilitate removal of a retainer 12a, as discussed below in further detail. The side and bottom panels 22a, 23a may be substantially rigid as well, but preferably are made of an elastic member attached to the front and back panels 18a, 20a (such as by sewing, welding, etc.). Instead of being discrete panels separated by a distance D2, the side and bottom panels 22a, 23a may be unitary, thereby forming one continuous panel connecting the front and back panels 18a, 20a.

The side and bottom panels 22a, 23a may connect an inner surface 18a′ of the front panel 18a with an inner surface 20a′ of the back panel 20a. As shown in FIG. 9a, movement of the front panel 18a in the direction of the action arrows exposes the side and bottom panels 22a, 23a. This arrangement of panels enables accommodation of various shaped and sized portable electronics, thereby forming a “universal” protective case.

As shown in FIG. 6b, the front panel 18a of the case 10 also includes a recess or indentation 24a. In one embodiment, the indentation 24a includes an opening 26a through the outer surface 18a″ of the front panel 18a. The opening 26a may be formed by cutting the desired shape through the indentation 24a of the outer surface 18a″ of the front panel 18a. Preferably the opening 26a has a surface area A′ smaller than the surface area B′ of the indentation 24a.

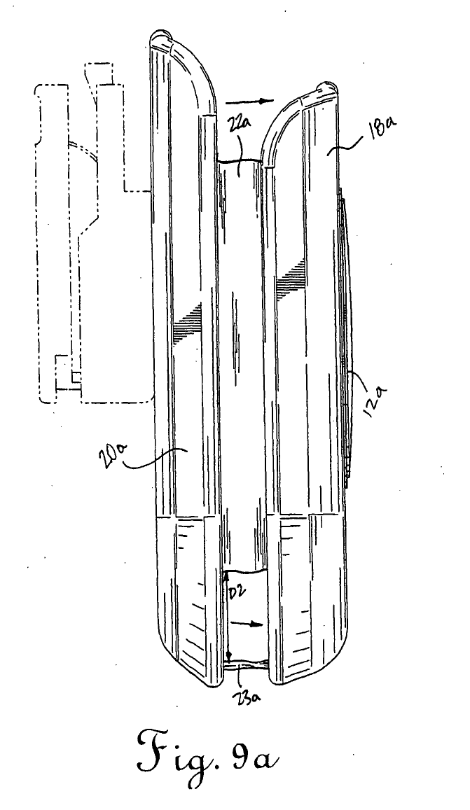

In the illustrated embodiment, the opening 26a includes a plate 42. As shown in FIG. 8, the plate 42 may have a surface area C′ greater than the surface area B′ of the indentation 24a, such that the plate 42 may be retained between the outer surface 18a″ of the front panel 18a and the inner surface 18a′ of the front panel 18a. Additionally, an adhesive or other material may be used to retain the plate 42 in the desired position in the opening 26a. The plate 42 also includes a plurality of apertures 44 adapted for receiving a base, such as the retainer support 46.

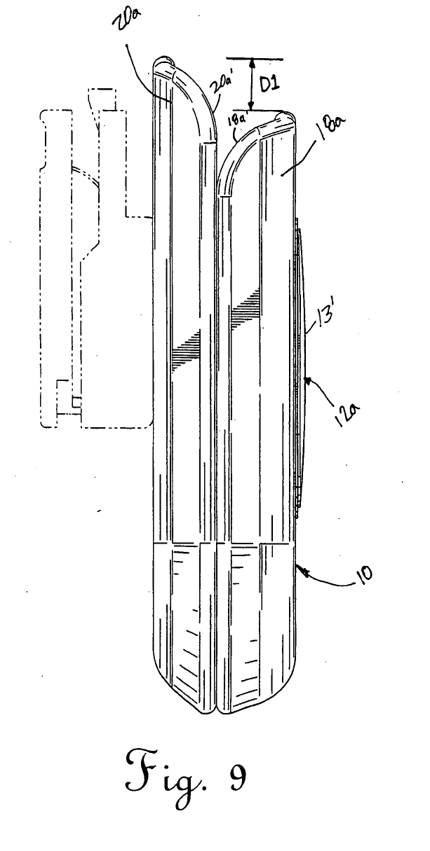

Turning to FIGS. 6a, 6b, 7, and 7a it can be seen that the retainer support 46 attaches to the plate 42 via insertion of a plurality of projections 48 into the apertures 44. Preferably, the number and placement of the projections 48 on the retainer support 46 corresponds to the number and placement of apertures 44 on the plate 42. In this arrangement, the retainer support 46 attaches to the plate 42 via a snap-fit. Alternatively, the retainer support 46 may attach to the plate 42 via adhesive, welding, or otherwise. In the illustrated embodiment, the retainer support 46 has a surface area D′ substantially identical to the surface area B′ of the indentation 24a.

Additionally, the thickness T of the retainer support 46 may substantially correspond to the depth of the indentation 24a so that the retainer support 46 is substantially flush with the outer surface 18a″ of the front panel 18a. As shown in FIGS. 6a and 7, the retainer support 46 includes at least one aperture 50 adapted for receiving the retainer 12a. Preferably, the retainer support 46 includes a plurality of apertures 50 positioned in an opposed relationship, such as at a first end 46a and a second end 46b. However, as should be appreciated by a skilled artisan, the retainer support 46 may include any number or configuration of apertures 50 for receiving the retainer 12a.

In the illustrated embodiment, the retainer support 46 also includes a channel 52 for receiving a portion of the retainer 12a. As shown, the channel 52 is positioned substantially along the perimeter of the retainer 12a. In this configuration, a portion of the retainer 12a is received or seated in the channel, such that the retainer 12a lies in substantially the same plane as the outer surface 18a″ of the front panel 18a.

As shown in FIG. 6a, the retainer 12a in the illustrated embodiment includes one or more projections or tabs 54 extending from the retainer 12a, such as for example from an inner surface 13 thereof. Preferably, the number and placement of the tabs 54 on the retainer 12a corresponds to the number and placement of the apertures 50 on the retainer support 46. The tabs 50 may take the form of a lipped projection 54a, a curved projection 54b, a combination thereof, or any other configuration that permits engagement of the retainer 12a on the retainer support 46.

When using a combination of curved projections 54b and lipped projections 54a, the engagement of the curved projections 54b with the apertures 50 of the retainer support forms a type of hinge enabling a user to associate an insert with the retainer, as discussed below in further detail. The lipped projections 54 may engage separate apertures 50 of the retainer support 46 to permit a snap-fit engagement of the retainer 12a. The retainer 12a may also include an edge or lip 56 that may rest in the channel of the retainer support. The lip 56 and channel 52 arrangement facilitates retention of an insert 16 between the retainer 12a and the retainer support 46. This arrangement also permits the retainer to lie substantially in the same plane as the front panel 18 of the case 10. However, as shown in FIG. 9, an outer surface 13′ of the retainer may also be slightly convex. This curved outer surface 13′ may function to magnify the insert, and it also provides the case 10 with a unique aesthetic appearance.

With reference to FIGS. 6a and 9b, to associate the retainer 12a with the retainer support 56, the user inserts the curved projections 54b into the apertures 50 of the retainer support 56. At this point the user may associate an insert 16 with the retainer 12a while it remains in an extended position to create a hinge. To accomplish this, a user may place the insert 16 on the retainer support 46 and lower the retainer 12a towards the retainer support 46 and to a home or retracted position. The user then depresses the retainer 12a, thereby engaging the lipped projections 54a with the apertures 50 of the retainer support 46 in a snap-fit engagement. Since the channel 52 receives a portion of the retainer 12a, the inner surface 13 is in close proximity with the retainer support 46. Thus, the insert 16 when present becomes “sandwiched” between the retainer 12a and the retainer support 46.

Turning to FIG. 9b, replacing the insert 16 is accomplished by grasping the case 10 and applying force in the direction F′. This back-bending of the corresponding panel 18a carrying the retainer support 46 disengages the lipped projections 54a. Once disengaged, a user may move a lower region 15 of the retainer 12a in a direction Z and about the hinge created by the curved projections 54b to allow for removal of the existing insert 16 and installation of a new one.

After removing and replacing the insert, the user may simply re-engage the lipped projections 54a with the apertures of the 50 of the retainer support 46, as previously described. As should be appreciated, the engagement of the curved projections 54b of the retainer 12a with the apertures 50 of the retainer support 46 enables a user to hingedly move the retainer 12a, thus obviating the need to completely remove the retainer 12a when replacing or removing an insert 16. However, the curved projections 54b also allow a user to completely remove the retainer 12a without significant effort.

The case 10 may be fabricated from well-known types of materials, with foam backed leather or vinyl being the preferred choices for the front and back panels 18, 20. Such materials are preferred because of the high-quality appearance afforded, durability, and ability to retain the indentation 24 through the application of heat, pressure, etc. However, the use of plastic or similarly rigid, wear-resistant materials is also possible. The remaining panels 22, 23 are preferably fabricated from a resilient fabric having an elastic quality, such as LYCRA, SPANDEX, etc. As explained above, the use of such a material permits insertion of various sizes of devices into the open end of the case 10, while generally ensuring that a secure fit is established. The retainer 12 may be formed of any material including metal or polymers, but is preferably fabricated from stainless steel, which provides it with both high strength and durability. The retainer 12a is preferably fabricated from polymeric materials, such as acrylics, polycarbonates, or polystyrenes. Additionally, the retainer support 46 is preferably made from similar polymeric materials, but may also be formed of a metal. The plate 42 may be formed of any material including metal or polymers, but is preferably fabricated from stainless steel or aluminum, which provides it with both high strength and durability. The holder 14 is preferably fabricated from polymeric materials, such as acrylics, polycarbonates, or polystyrenes. Such materials facilitate the welding of the retainer 32 to the cover 34, such as by using thermal processes (e.g. ultrasonic or laser welding techniques).

It is also contemplated that the case 10 forming one aspect of the present invention may be sold as a kit with a plurality of inserts 16. The inserts 16 may each bear a different image (such as the logo of a different sports team, race car driver, etc.) and maybe packaged and displayed together with the case 10 (and with advertising materials or packaging describing the “theme” or genre, as well as instructions for customization), or separately. Instead of pre-printed inserts, providing a kit including a case with a plurality of blank, user customizable inserts is also contemplated (including with associated stickers or decals for application to the inserts), as is providing one or more inserts with different images on the opposed sides thereof. The kit may also comprise the portable electronic device, such as a mobile phone, in which case the availability of the user customizable case 10 offers a point of distinction that may cause a prospective purchaser to select that particular brand of device as compared to another. Various other accessories for the devices (chargers, memory cards, etc.) may also be sold in kit form with the case and insert(s).

The invention also includes the method for manufacturing the case having an insert and an opening adapted to receive a retainer, as well as a method of forming the holder for retaining the image. Also, the invention includes the method of customizing the case via insertion of an insert into the holder, as well as insertion of the holder into the retainer fixed to the case. Still further, the invention includes a method of providing a kit including the case and insert(s), or a kit with the device, case, and insert(s).

The foregoing descriptions of various embodiments of inventions are provided for purposes of illustration, and are not intended to be exhaustive or limiting. Modifications or variations are also possible in light of the above teachings. For example, a removable top panel, flap, or cover may be provided for securing the device in the case 10. Instead of the flap 32, the cover 34 forming part of the holder 14 may be movable between a home position and a second position to facilitate insertion of the insert 16. Also, the case, retainer, holder, and image may be any size, shape, or design Furthermore, the retainer and holder may be positioned anywhere on the case. Additionally, the case may be manufactured, used and sold with or without the retainer, holder, image, or any combination thereof. For example, the image or indicia could be provided on the holder 14 itself, which would thus form the insert 16. Also, the retainer 12 and the insert 16 could be provided as a one-piece unit, thus eliminating the need for the separate holder 14. Still another option is to eliminate the retainer 12 altogether, with the flap 32 functioning as the fastener (clip 30) for associating the holder 14 bearing an image or indicia with the case 10. Additionally, the retainer 12a and the retainer support 46 (with our without the base 42) may also be formed as a one-piece unit. As shown in several of the figures, a removable belt clip may also be provided on the panel of the case 10 opposite the image, and may be held in place using a fastener/slot/pocket arrangement, or any other means. The embodiments described above were chosen to provide the best application to thereby enable one of ordinary skill in the art to utilize the disclosed inventions in various embodiments and with various modifications as are suited to the particular use contemplated. All such modifications and variations are within the scope of the invention as determined by the appended claims when interpreted in accordance with the breadth to which they are fairly, legally and equitably entitled.

1. A kit for protecting and customizing a portable electronic device, comprising:
a plurality of inserts, each adapted for receiving an indicia; and
a case including an open end for receiving the device and a retainer for removably holding at least one of the inserts, such that the insert may be visualized and then replaced, as desired, to customize the device.

2. The kit of claim 1, wherein the retainer hingedly attaches to the case to facilitate insertion and removal of the insert during customization.

3. The kit of claim 1, in combination with the portable electronic device.

4. The kit of claim 3, wherein the portable electronic device is a mobile phone.

5. The kit of claim 1, further including instructions for replacing the insert.

6. The kit of claim 1, wherein the inserts and case are displayed in a common package.

7. The kit of claim 1, further including decals corresponding to the inserts.

8. A user-customizable case for a portable electronic device, comprising:
a body including a first and second panels; and
a retainer for an insert for receiving an indicia, wherein the first and second panels are elastically connected to define a compartment for the device and the retainer is removably attached to the first panel to allow for replacement of the insert to customize the device.

9. The case of claim 8, further including a recess in the first panel for the retainer.

10. The case of claim 8, wherein the retainer hingedly attaches to the body.

11. The case of claim 8, wherein the retainer attaches to the body by snap-fit engagement.

12. The case of claim 8, wherein the insert bears a pre-printed logo.

13. A user-customizable case for a portable electronic device, comprising:
a body including an elongated front panel with a corresponding back panel;
at least one elastic member securely connecting the front panel with the back panel to form a compartment; and
a retainer for holding an insert, said retainer being removably attached to the body.

14. The case of claim 13, wherein the retainer attaches to the body via a snap-fit engagement.

15. A user-customizable case for a portable electronic device, comprising:
a body including an open end for receiving the portable electronic device;
at least one insert bearing an indicia; and
a retainer for holding the insert, the retainer being hingedly attached to the body for inserting, removing, or replacing the insert to customize the case.

16. The case of claim 15, wherein the retainer attaches to the body by snap-fit engagement.

17. A method of associating an insert with a user-customizable case for a portable electronic device, comprising:
moving a retainer associated with the case from a retracted position close to the case to an extended position away from the case;
positioning the insert between the retainer and the case; and
returning the retainer to the retracted position to associate the insert with the case.

18. The method of claim 17, further including the step of placing a logo on the insert, wherein the logo is visible when positioned between the retainer and the case.

19. The method of claim 17, wherein the retainer includes a locking projection for engaging a support associated with the case, wherein the step of moving the retainer is preceded by releasing the locking projection from engagement with the support.

20. The method of claim 19, wherein the step of releasing the locking projection comprises back-bending a panel of the case carrying the support for the retainer.

21. A method of facilitating customization of a portable electronic device, comprising:
providing a case including an open end for receiving the portable electronic device, the case including a removable retainer for at least one insert; and
providing a plurality of different inserts for the retainer, such that the inserts may be exchanged for each other in the retainer to customize the case.

22. The method of claim 21, wherein the inserts bear pre-printed logos, and further including placing at least one insert in the retainer and at least one insert adjacent the case for display.

23. The method of claim 21, further including commonly packaging the case and inserts.

24. The method of claim 23, further including commonly packaging the portable electronic device with the case and inserts.

25. The method of claim 21, further including displaying the case and inserts together.

26. The method of claim 21, further including providing decals for the inserts.
